(19) United States
(12) Patent Application Publication
(10) Pub. No.: US 2014/0218263 A1
(43) Pub. Date: Aug. 7, 2014

(54) RADOME

(71) Applicant: Hella KGaA Hueck & Co., Lippstadt (DE)

(72) Inventors: Heiko Burdenski, Tunau (DE); Volker Redwanz, Binzen (DE); Murat Arslan, Schonau (DE); Stefan Greiner, Efringen-Kirchen (DE); Karl-Heinz Kandler, Schluchsee (DE); Torsten Schmidt, Lorrach (DE)

(21) Appl. No.: 14/342,072

(22) PCT Filed: Aug. 30, 2012
(86) PCT No.: PCT/EP2012/066862

§ 371 Date: Feb. 28, 2014

(30) Foreign Application Priority Data
Aug. 30, 2011 (DE) 10 2011 053 104.1

(51) Int. Cl. H01Q 1/42; H01Q 1/32

(52) U.S. Cl. CPC H01Q 1/42; H01Q 1/325
USPC 343/872; 156/278

(57) ABSTRACT

A radome for the installation in the front section of a motor vehicle, includes the radome being assembled from at least two plates, made from plastic, which are adhered to each other. The radome forms a pattern. A metallic part of the pattern is vapor coated on an interior of a first plate in an accurately fitting fashion as a metallic layer and that the interior with the vapor coated metallic layer is covered with a lacquer coating. A method for the production of such a radome is also disclosed.

### CROSS REFERENCE

This application claims priority from PCT Application No. PCT/EP2012/066862, filed Aug. 30, 2012, which in turn claims priority from German Patent Application No. 10 2011 053 104.1, filed Aug. 30, 2011, each of which is incorporated by reference herein in its entirety.

### TECHNICAL FIELD OF THE INVENTION

The invention relates to a radome for the installation in a front section of a motor vehicle, with the radome forming a pattern and with the radome being assembled from at least two plates made from plastic, which are adhered to each other. The invention further relates to a method for producing such a radome.

### BACKGROUND OF THE INVENTION

Increasingly modern safety systems are used in motor vehicles. This includes, e.g., an automatic distance control, which keeps the distance to other vehicles driving ahead at a largely constant value by an automatic accelerating or braking. The distance is determined via a radar sensor, which is installed in the front section of the vehicle, invisible from the outside, and transmits distance signals to the corresponding processing and control unit.

The radar sensor is preferably fastened behind a radiator grill of the motor vehicle (opposite the normal direction of movement) and is largely shielded by a radome (cover for a radar device) from weather influences. The radome may be embodied as a lens for the radar beams. In many motor vehicles, an emblem or logo is integrated in the radiator grill, which is embodied as a pattern on a plate or a flat bowl. It is known to use this plate or bowl as a radome—thus to fasten the radar sensor behind said emblem or logo—and to produce it from appropriate materials, which are permeable for the radar beams and at least partially impermeable for visible optic radiation. The production of this radome is expensive and costly, though; this particularly applies when the emblem or logo shall have a high-quality and expensive appearance, because then surfaces appearing to be non-metallic—prior to vapor coating of materials with a metallic appearance—must be coated on an interior of the plate by way of embossing over several steps in an accurately fitting fashion in an expensive process.

DE 100 28 801 A1 describes a radome with a pattern (emblem) for a motor vehicle. The radome is made from a transparent plastic, one surface of which is provided with a metallic coating in a grid-like fashion. Through the grid-like coating, the permeability for the radar beams shall be improved here. The application of the coating is relatively expensive.

A radome with a pattern is known from DE 198 19 709 C2, in which the pattern is integrated in a plate as a relief. The relief is provided with a metallic coating, permeable for radar beams; the remaining interior areas of the plate are lacquered in a dark or opaque fashion. The rear of the plate is either back injection molded with plastic, or another plate is adhered thereto, on which the relief is embodied as an elevation. A front of the radome may be sealed with a protective coating. This radome is also expensive in its production, particularly because the lacquer application must occur in several steps.

US 2002/0171579 A1 discloses a radome with a pattern. The radome is made from at least one front plate and one rear film. On the front plate a non-reflective part is applied as a negative of the pattern, e.g., via a lacquer. A metallically reflective part is formed on the rear film, preferably comprising a plurality of wires, which are arranged perpendicular in reference to the polarization of the radar beams. Preferably the rear film is arranged between the front plate and a rear plate. This radome is also expensive in its production, particularly because many adhesion sites are necessary. Additionally here optic problems arise, such as blurred contours of the reflective part, because it is not arranged directly on the front plate.

### SUMMARY OF THE INVENTION

A plate-shaped body is defined in the sense of the invention as a plate, which is planar or slightly arched, e.g., embodied as a flat spherical or ellipsoidal bowl.

A patterns shall be understood as any arbitrary emblem, logo, or otherwise appearing image, such as a representation of a part of a radiator grill.

Interior, interior side etc. refers to an alignment, when installed in a motor vehicle, in reference to a radar sensor and an interior cabin of the motor vehicle. An interior side of the plate therefore faces the radar sensor, for example. For the exterior, the reverse applies accordingly.

A first objective of the invention is to provide a radome that meets the highest aesthetic expectations and can be produced with as little, expense as possible.

A second objective is to provide a method for producing a corresponding radome.

A metallic part of the pattern is vapor coated on an interior of a first plate in an accurately fitting fashion as a metallic layer, and the interior including the metallic layer is covered with a lacquer coating. By the accurately fitting vapor coating it is achieved that the pattern becomes visible and appearing metallic when the exterior of the first plate is observed. Here, a layer thickness of said metallic layer is selected such that it has just reached opaqueness. Here, in an accurately fitting fashion means that the contours of the pattern precisely follow the pattern, e.g., the logo, and no blurring or deviations from said pattern are visible. The accurately fitting vapor coating is achieved via a stencil, which is pressed elastically onto the interior of the first plate and shows the contours of the pattern as openings. After the vapor coating process the interior is covered with a lacquer coating. In addition to optic effects, the lacquer coating serves as a protection for the metallic layer.

In reference to radomes of prior art, in the production of the radome according to the invention at least the application of one additional protective coating is omitted, so that the production overall is less expensive. In spite of this, the radome with the pattern appears expensive, due to the accurate, sharp contours.

In one embodiment the metallic layer is made from gold, tin, or indium. On the one hand, these metals result in the desired metallic reflection and, on the other hand, due to the layer thickness used here, they have no compromising influence upon the permeability of the radome for the radar beams.

The lacquer layer is either clear or transparent; colored parts of the pattern are then formed by the second plate. Alternatively, the lacquer layer is colored and opaque, with the color coinciding with the stencil of the pattern. This leads to a particularly brilliant effect.

In another embodiment the exterior of the first plate is provided with a protective coating. This protective coating is made from a clear, transparent material, which shows high mechanic stability. This way, the high-quality appearance of the radome remains over an extended period of time.

In another embodiment the pattern is embodied three-dimensionally. This means, that the pattern is integrated as a recess on the interior of the first plate. This leads to a particularly high quality appearance of the pattern.

The production method comprises the following steps:
Producing at least one first plate and one second plate;
Covering a detail of an interior of the first plate in an accurately fitting fashion using a stencil;
Vapor coating a detail of the interior not covered with a metallically reflective material;
Removing the stencil;
Covering the interior of the first plate including the metallically reflective material with a lacquer layer;
Adhering the plates.
   When producing the plates, perhaps a three-dimensional embodiment of the pattern is considered. For this purpose, the three-dimensional structure is embodied as recess(es) on the interior of the first plate and as elevation(s) on the exterior of the second plate. The plates are made in an injection-molding process, for example.

The stencil shows a pattern, with it being exposed and the remainder of the interior of the first plate being covered. The stencil is pressed slightly and elastically against the interior such that the edges contact in a tightly sealing fashion. This way, during the subsequent vapor coating process clearly defined edges of the evaporated material develop on the interior. In case of a three-dimensional structure these edges coincide with the edges of the recess. Overall, here on and/or in the interior, without any post-processing, an accurately fitting, sharp image of the pattern develops, which is metallically reflective.

On the one side, the covering of the interior with the lacquer coating additional achieves an optic effect for the evaporated material and, on the other side, a protection for said material, which due to its very low thickness is susceptible to mechanic stress, such as scratching when the plates are adhered. Another protective coating is therefore not required, here.

Overall, using relatively low expenses the radome can be produced with an expensively appearing pattern.

In one embodiment, as an additional step, a protective coating is applied on an exterior of the first plate. This occurs, e.g., before or after the adhesion of the plates.

In another embodiment, the radome is tempered. This way, internal stress is generated and the curing of the adhesive is accelerated.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a top view of an interior of a first plate,

FIG. 2 a cross-section through the first plate,

FIG. 3 a cross-section through a radome, and

FIG. 4 a cross-section through the first plate with a stencil being pressed thereupon.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

A motor vehicle is equipped with an automatic distance control. For this purpose, it shows a radar sensor, which is fastened in a front section of the motor vehicle. The radar sensor is arranged behind a radiator grill, this means between the radiator grill and a radiator located therebehind at a distance (here, behind and therebehind refers to the direction opposite the forward motion of the motor vehicle). The radar sensor is covered by a radome.

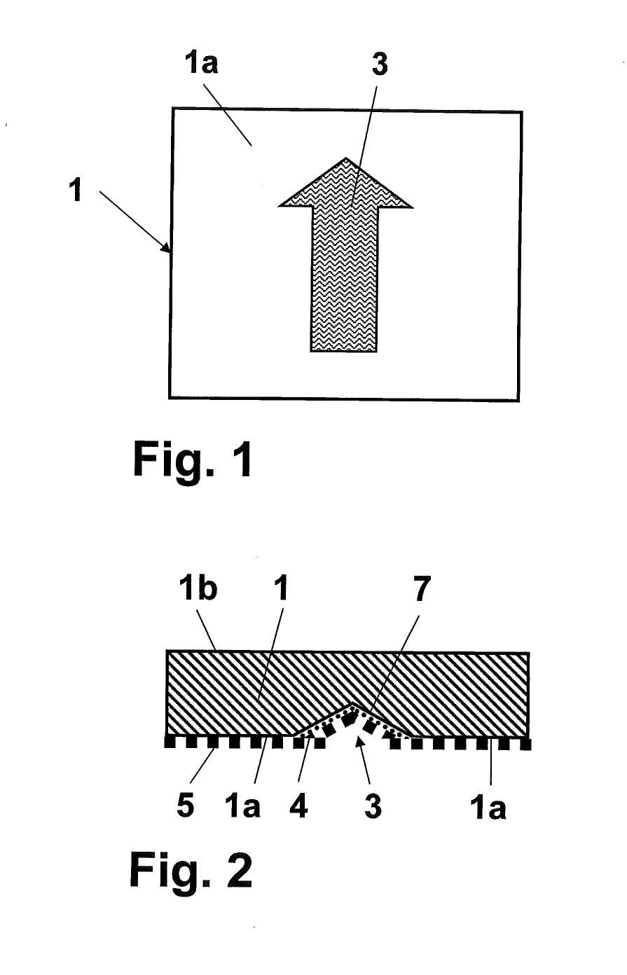

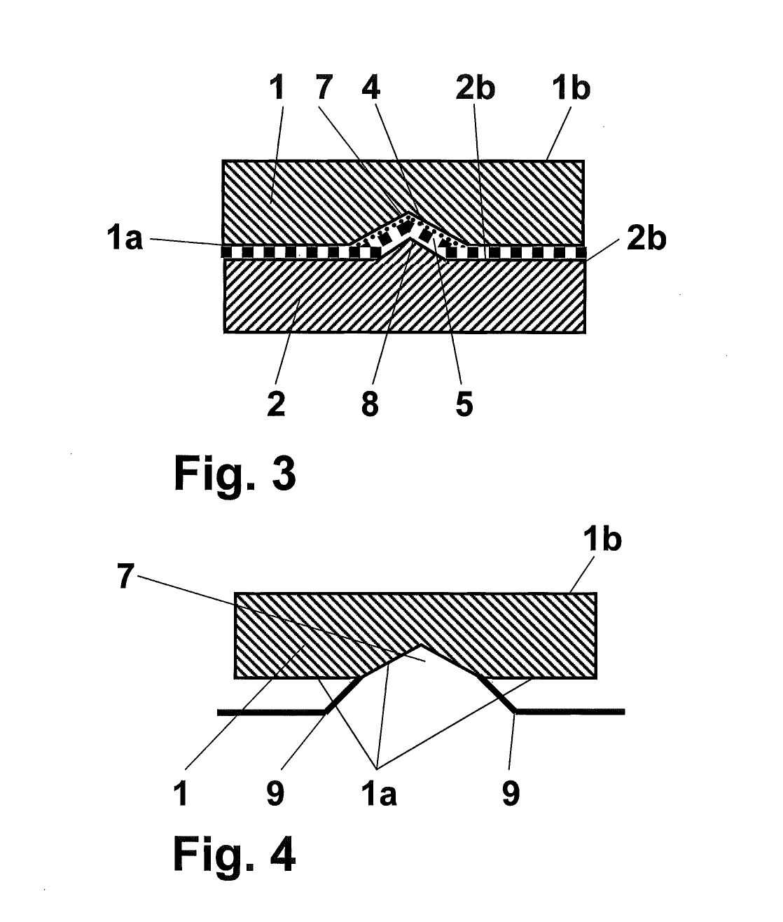

As discernible from FIGS. 1 through 3, here the radome comprises a first plate 1 and a second plate 2, which are adhered to each other. The plates 1, 2 are either planar, slightly arched, or embodied in the form of a flat bowl. The radome overall may be lenticular.

The radome forms a pattern 3, which in an exemplary fashion is shown in FIG. 1 as an arrow and which shall be metallically reflective. For this purpose, the pattern 3 is applied mirror-inverted on an interior 1a of the first plate 1 in an accurately fitting fashion as a thin metallic layer 4 via precipitated metallic vapors. Here, the contours of the pattern 3 exactly match a predetermined pattern, e.g., a company symbol (signet, logo, emblem), with the predetermined areas being provided with the metallic layer 4 and precisely matching the predetermined pattern, which here means without any unintended omissions and without unintentionally coated areas. The thickness of the metallic layer 4 is sized here such that it is impermeable for optic radiation, but permeable for radar beams.

A lacquer layer 5 is applied on the metallic layer 4 and the interior 1a of the first plate 1. The lacquer layer 5 comprises here an opaque colored material with a thickness of approx. 25 to 40 μm, with the term colored including white. The metallic layer 4 and the interior 1a are also covered by the lacquer coating 5 such that protection is ensured from mechanic influences and perhaps corrosion.

A protective coating 6 comprising a hard material is applied on an exterior 1b of the first plate 1.

Due to tempering the radome shows little tension or is free of tension.

A water-tight but gas-permeable membrane is fastened on the interior of the radome, in order to seal a penetrating bore of the second plate. This way, pressurization can occur between a space, in which the plates 1, 2 are formed, and the environment, without here water can penetrate this space.

In some applications, an exterior circumference of the radome is tightly surrounded by a frame, not shown, e.g., made from metal. The frame is either a design element or a part of the logo or emblem.

All materials of the radome, except for the frame, are selected such that they are permeable for radar beams. The first disk 1 is made from a clear, transparent plastic, such as polycarbonate (PC) and the second disk 2 from an opaque, colored plastic, e.g., acrylonitrile styrene acrylate (ASA) or acrylonitrile butadiene styrene (ABS). The metallic layer 4 is made from gold, tin, or indium, the lacquer coating 5 from plastic, e.g., a hydro-protective lacquer 1K from the company Warnecke & Bohm and the protective layer 6, e.g., from a silicone lacquer. The layer thicknesses are shown distorted in the figures.

In one preferred embodiment the pattern 3 is embodied three-dimensionally. For this purpose, the pattern 3 is inserted as a recess 7 into the interior 1a. A corresponding elevation 8 is embodied on an exterior 2b of the second plate 2 in consideration of the lacquer layer 5, in order to avoid any distortion of the radar beams.

In order to produce the radome first the plates 1, 2 are produced in an injection molding process.

A stencil 9 is pressed slightly in a predetermined alignment onto the inside 1 a of the first plate 1, with here a three-dimensional embodiment being considered, if applicable (see FIG. 4). The stencil 9 is produced, e.g., from spring steel and comprises the pattern 3 as an opening with sharp contours, which abut tightly at the interior 1a and precisely at the edges of the recess 7, if applicable.

This way, the areas of the interior, which shall not be vapor coated with metal, are covered by the stencil with sharp edges, thus in an accurately fitting fashion, while the remaining areas are exposed.

These exposed areas are vapor coated with metal such that a very thin, opaque metallic layer 4 develops.

After the vapor coating process the stencil 9 is removed from the first plate 1. The interior 1a of the first plate 1 with the metallic layer 4 is covered with the lacquer coating 5, by said coating being sputtered thereon. The lacquer coating 5 is then dried, e.g., with the help of an infrared emitter.

Subsequently the protective coating 6 is applied on the exterior 1b of the first plate 1 and dried.

Then the first plate 1 and the second plate 2 are adhered to each other via a silicone adhesive. For this purpose, the silicone adhesive is applied on the interior 1a of the first plate 1 in the edge region and then the second plate 2 is pressed with its exterior 2b onto the silicon adhesive—perhaps in consideration of the recess 7 and the elevation 8. This way the radome is formed.

The radome is then tempered at 60° C. for 30 minutes in order to accelerate the curing of the silicone adhesive and in order to reduce internal stress.

Before and after the tempering process, perhaps the frame is also clamped thereon. After the tempering process the membrane is adhered to the interior of the radome.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE CHARACTERS

1 First plate
1a Interior of the first plate
1b Exterior of the first plate
2 Second plate
2b Exterior of the second plate
3 Pattern
4 Metallic layer
5 Lacquer coating
6 Protective layer
7 Recess
8 Elevation
9 Stencil

1. A radome for installation in a front section of a motor vehicle, comprising:
at least two plates made from plastic, which are adhered to each other, said radome forming a pattern;
wherein a metallic part of the pattern is vapor coated on an interior of a first plate in an accurately fitting fashion as a metallic layer and that the interior with the metallic layer is covered with a lacquer coating.

2. The radome according to claim 1, wherein the metallic layer is made from gold, tin, or indium.

3. The radome according to claim 1, wherein the lacquer coating is colored and opaque.

4. The radome according to claim 1, wherein an exterior of the first plate is provided with a protective layer.

5. The radome according to claim 1, wherein the pattern is embodied three-dimensionally.

6. A method for producing a radome for the installation in a front section of a motor vehicle, comprising the following steps in the sequence listed:
producing providing at least one first plate and one second plate;
covering a detail of an interior of the first plate in an accurately fitting fashion using a stencil;
vapor coating of a detail not covered with a metallically reflective material;
removing the stencil;
covering the interior of the first plate including the metallically reflective material with a lacquer coating; and
adhering the plates to each other.

7. The method according to claim 6, wherein a protective layer is applied on an exterior of the first plate as an additional step.

8. The method according to claim 6, wherein the radome is tempered.
